(19) United States
(12) Patent Application Publication
(10) Pub. No.: US 2004/0223018 A1
(43) Pub. Date: Nov. 11, 2004

(54) Printing control apparatus, printing control method and printing control program product

(75) Inventor: Takashi Nagai, Nagano (JP)

Correspondence Address: HOGAN & HARTSON L.L.P., 500 S. GRAND AVENUE, SUITE 1900, LOS ANGELES, CA, 90071-2611, US

(73) Assignee: SEIKO EPSON CORPORATION

(21) Appl. No.: 10/787,896

(22) Filed: Feb. 26, 2004

(30) Foreign Application Priority Data
Feb. 28, 2003 (JP) 2003-52504

(51) Int. Cl. B41J 29/38

(52) U.S. Cl. 347/14

(57) ABSTRACT

The conventional technique to save printing paper is not generally applicable and is not able to substantially save printing paper. Its improvement includes acquiring the printing job data for execution of printing job, setting the printing area for each printing resolution, laying out printing images having the same printing resolution specified by the printing job data in the margin of the printing area for the same printing resolution, generating the layout data showing the layout, spooling the printing job data, and performing printing according to the layout data those images shown by spooled printing job data when the condition to start execution of the print job is met.

### BACKGROUND OF THE INVENTION

1. Field of the Invention

The present invention relates to a printing control apparatus, a printing control method, and a printing control program product.

2. Description of the Prior Art

An inkjet printer usually performs printing in such a way that the print head with ink nozzles traverses printing paper while depositing ink droplets thereon and printing paper is advanced after each traversal. This practice necessitates the image being printed to be justified in the direction of traversal, or the image is placed close to the left side of printing paper, for example. Left-justified printing leaves a useless margin at the right side of printing paper. This is true particularly with a wide-format printer for large printing paper (say, B0 size). Printing in this case does not always cover printing paper entirely, and the right margin is wasted. A conventional known way to avoid this trouble is to lay out images side by side in the lateral direction of rolled printing paper if more than one copy is to be printed for the same image. (See Fiery Spark Professional PS softlip PRO v2.0 Print Guide, corresponding to PX-10000/MC-10000/PM-10000, issued 2002, p. A-18,25 in appendix.)

The conventional technique mentioned above is not generally applicable and is not able to substantially save printing paper. It saves printing paper only when more than one copy is printed for the same print job, with the print size and resolution fixed throughout the printing run. Moreover, it cannot be used for images larger than one half the width of printing paper because such images cannot be laid out laterally side by side. In this case it is utterly useless for paper saving.

### SUMMARY OF THE INVENTION

The present invention was completed in view of the foregoing. It is an object of the present invention to provide a printing control apparatus, a printing control method, and a printing control program product, which are designed to reduce margin in printing paper automatically in most cases.

Printing control according to the present invention starts with the spooling of print job data, during which it sets print areas, each differing in printing resolution. Then it creates layout data, thereby sequentially laying out those images to be printed which have the printing resolution specified for individual print areas. As soon as the printing start condition is met, it prints the images according to the layout data. The print job data describes printing resolutions and image sizes. One printing resolution remains unchanged until printing on one area is completed and another printing resolution is employed for printing on another area. This procedure is applied to a printer with variable resolutions.

In printing according to the present invention, printing areas are set separately for different printing resolutions. If images described by the print job data have a certain printing resolution common to all, they are laid out in one printing area including margins, without their overlapping with one another. The images to be laid out and their positions for layout are specified by the layout data.

Thus, the spooled print job data tightly lays out images in one print area in which the specified printing resolution remains unchanged. This procedure helps save printing paper even in the case where more than one print job for images with different printing resolutions are entered at the same time. Moreover, in printing according to the present invention, the print job permits images to be laid out in margins so long as the images have a certain printing resolution common to all. Even print jobs different from one another permit images to be laid out automatically in a way to save printing paper so long as they are identical in printing resolution.

The print job data may be in any form so long as it contains data for execution of print jobs. For example, it may be written in page description language such as Postscript (a registered trademark of Adobe System). It should contain at least data specifying the printing resolution and the images to be printed; however, it may also contain additional data necessary for print jobs. Such additional data may indicate print size (represented in terms of pixels or length) which is obtained by interpreting images to be printed. Incidentally, images to be printed include characters, pictures, figure, tables, etc.

The data for printing start condition may be in any form so long as it indicates the start of printing for temporarily stored (spooled) data. It may concern the number of print jobs that can be accumulated, and then it permits spooling to continue until the specified number of accumulation is reached. It may concern the size of images, and then it permits spooling to continue until the specified size is reached. It may concern the time which has elapsed after the start of spooling, and then it causes printing to wait for a certain length of time after spooling. It may concern the ratio of the image area to the printing area, and then it permits spooling to continue until a specific ratio is reached.

The data for printing start condition may specify more than one user who enter the print job data individually. Such data permits individual users to perform printing on their favorite printing paper separately. Thus, it causes printing to start after individual users have completed their spooling.

Who or what enters the print job data may be a user or a computer. Who or what has entered the print job data may be known from data contained therein; alternatively it may be added to the header of the print job data.

The printing area should specify an area in which images are laid out. It may be expressed at least in terms of length and breadth (in mm or inch). Coordinate data may be used to specify the positions of four corners of a square or two end points of a diagonal line. The size of the printing area may be specified in terms of the capacity of the buffer in which print images are stored. Such data should include information about the image size (such as the number of pixels to be laid out in two dimensions).

The printing area may be set after the print job data specifying a new printing resolution has been entered; alternatively it may be prepared previously. In the case where the print job data is spooled by different users as mentioned above, it is desirable to set printing areas for respective users. In other words, if there are different users for a printing resolution common to them, it is necessary to set different printing areas for individual users.

The spooling means is not specifically restricted so long as it is capable of creating image layout data and storing print job data. The former specifies the layout of images in the printing area allocated for images having a printing resolution common to them. Upon knowing the size of images to be printed, it is possible to judge whether or not the images of interest fit to the print areas. The results of judgment help determine the position of images in the print area such that images are justified to the top and left of the print area. Images represented by the print job data that is entered later may be laid out in the margin of the print area which the print head traverses. In this way margins can be effectively reduced.

The layout of images in the printing area may be specified in terms of coordinates described in layout data. The layout data may assume any form; for example, it may be written in that part of the print job data which describes the position of images. The print job data may be accumulated in various types of recording media, such as hard disc, RAM, and EPROM.

A series of print job data to be spooled may form a single file if they specify the layout data for images having a printing resolution common to them. In other words, it is desirable that a single file specifies images and printing resolution if images are to be printed in a certain range of printing area. Such a file structure particularly facilitates printing for images laid out in the lateral direction of printing paper.

The advantage of the single file structure composed of data for printing in a specific printing area is that it is only necessary for the user to specify one printing resolution for printing to be executed according to this file and that the user can specify the image position with each print job simply by adding the layout data to the file. The file should also include the data of images. In the case where files written in a page description language have already been spooled and additional files containing print jobs are entered, then the existing spool files may be given that part of the file describing the images and the layout data specifying the images in the print job.

Moreover, if there is no sufficient margin for the printing area at the time of spooling, it is possible to extend the printing area in the longitudinal direction of printing paper. In this way, it is possible to secure necessary margins in the printing area and lay out the images there.

Any means may be used for printing so long as it executes printing in conformity with the print jobs and layout data. If the print job data is written in page description language, it should interpret the language and perform color conversion and half-toning, thereby generating print data, and send it to the printer. The print executing means may be any general-purpose module if the layout data is written formally in page description language; however, it should be one which executes printing according to the spooled print job data containing the layout data.

The present invention will be embodied in various ways. For example, the printing control apparatus may be used alone or incorporated into any other machines. The printing control method is necessary for image layout at the time of spooling. The printing control program product is designed for the printing control apparatus and method.

The program product may be offered in the form of magnetic recording medium or magneto-optical recording medium or any other recording medium which will be developed in the future. The idea of the present invention may be materialized partly in software and partly in hardware. The program product recorded on a recording medium will be read whenever necessary. It may be a primary copy or a secondary copy whatsoever.

### BRIEF DESCRIPTION OF THE DRAWINGS

FIG. 1 is a block diagram showing the constituents involved in the printing control process.

FIG. 2 is a flowchart of the procedure executed by the printing control program.

FIG. 3 is a flowchart of the process for generating the layout data.

FIG. 4 is a diagram showing actions to be invoked by the print jobs.

### DESCRIPTION OF THE PREFERRED EMBODIMENTS

The embodiments of the present invention will be described below in the following order.

(1) Structure of the printing control apparatus:

(2) Printing control process:

(2-1) Layout data generation:

(3) Printing control action:

(4) Additional embodiments:

(1) Structure of the Printing Control Apparatus:

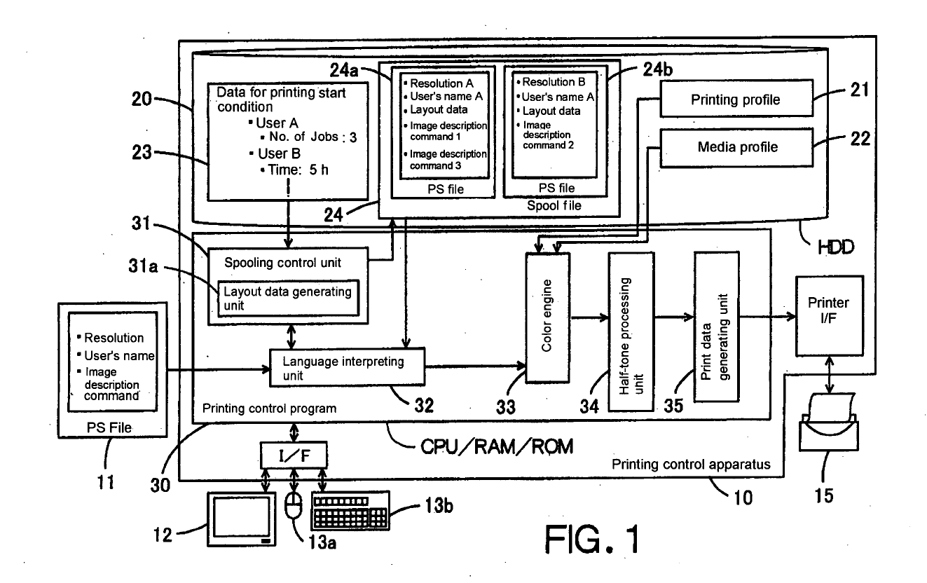

FIG. 1 is a block diagram showing the printing control apparatus 10 as one embodiment of the present invention. The printing control apparatus 10 is a PC-based unit having CPU, RAM, ROM, etc. for program execution (not shown), fixed storage such as HDD (hard disk drive), and interfaces I/F for connection to a printer 15, a display 12, a mouse 13a, and a keyboard 13b. It acquires through a network (not shown) a PS (PostScript) file 11 generated by a PC and parses it to generate print data to be transferred to the printer 15, which performs printing according to the print data.

The printer 15, which is connected to the printing control apparatus 10 through the printer I/F, carries four color inks (CMYK) and ejects them onto a printing medium to produce images thereon. The HDD 20 stores more than one printing profile 21 and more than one media profile 22. The printing profile 21 is a program which converts data representing colors for images on the display 12 in terms of CMYK color system into data representing colors in terms of Lab color system. The media profile 22 is a program which converts data representing colors in terms of Lab color system into data representing colors in terms of CMYK color system to be used by the printer 15.

These profiles are not specifically restricted so long as they are capable of conversion from a device-dependent color system (which depends on display or printer) into a device-independent color system. They may use the XYZ color system in place of the Lab color system. In addition, the printer 15 may use the CMYKlclm color system or any other ones in place of the CMYK color system. In this embodiment, color conversion is accomplished by means of the printing profile and media profile; however, color conversion may be accomplished by means of any LUT which prescribes correspondence between the data for colors used by the display 12 and the data for colors used by the printer 15.

The HDD 22 previously stores the data 23 for printing start condition, which contains the names of the users who enter the print jobs. In the instance illustrated in FIG. 1, two users (A and B) are registered. The printing start condition for User A is that printing starts after his three print jobs have been spooled, and the printing start condition for User B is that printing starts five hours after his first print job has been entered.

Whether or not the number of print jobs satisfies the printing start condition is judged from the print job number (mentioned later). In this embodiment, images for printing specified by the print job are sequentially numbered, so that if the image number matches the print job number, it is judged that the number of print jobs satisfies the printing start condition. Whether or not time elapsed after the first print job has been entered meets the printing start condition is judged from elapsed time measured by the computer's clock.

The printing start condition may be modified variously; for example, it may be prescribed by the ratio of the size or area of images to the area of printing paper. The size of images and the size of printing paper are known from the PS file specifying the image description command and printing paper. It is only necessary to compare such data with the previously registered data for the printing start condition.

The HDD 20 stores the spool files 24. In this embodiment, the spool files 24 which are stored are PS files. Images specified by the same resolution and user are contained in a single PS file to be spooled. In the instance shown in FIG. 1, the PS files 24a and 24b execute the print jobs entered by user A. These PS files specify resolution A and resolution B, respectively.

The printing control program 30 consists of the spooling control unit 31, the language interpreting unit 32, the color engine 33, the half-tone processing unit 34, and the print data generating unit 35. The PS film 11 is created by the photo-retouch software which works on the user's PC, and it is transferred to the printing control apparatus 10 through a network (not shown) when the print job is entered. The PS file 11, which has been transferred to the printing control apparatus 10, is entered to the language interpreting unit 32.

The PS file 11 contains the resolution for printing, the user's name, and the image description command, which are specified by the printer driver which is invoked when the user enters the print job into his PC. In this embodiment, the user's name is a name which has previously given to a specific PC. This PC name (as the user's name) is written in the PS file 11, so that the user who has entered the print job through the PC is specified. The user's name to be registered with the data 23 for printing start condition is the one which is written in the PS file 11. The PC name of the PC which was connected to the network when the data 23 for printing start condition was created should match the user's name which is registered with the data 23 for the printing start condition.

Needless to say, the PS file 11 may contain, in addition to the above-mentioned information, additional information about the make of the printer that carries out printing, the kind of the printing paper, and the print profiles. Such additional information, e.g., the user's name, may be available through two-way communication between the printer driver and the printing control program for the printing control apparatus 10.

The language interpreting unit 32 is a module that parses PostScript language of the PS file 11. It recognizes the resolution, user's name, printer, printing paper, and printing profile, etc. and it also selects a media file suitable for the recognized printing paper. Moreover, it parses the image description command to constitute the images and characters with dot matrix pixels and also create the CMYK image data that expresses the color of each pixel in tone values.

The spooling control unit 31 is a module that works in concert with the language interpreting unit 32 in order to spool the PS file 11. In other words, when the printing control apparatus 10 acquires the PS file 11, the spooling control unit 31 acquires the printing resolution and user's name which have been parsed by the language interpreting unit 32. Then it references the printing start condition 23 and spools the acquired PS file 11 in the HDD 20 if the acquired user's name has been registered with the printing start condition. If a PS file has already been spooled in the HDD 20, it retrieves the resolution and user's name described in the existing PS file. If it is found that the retrieved resolution and user's name are identical with those in the acquired PS file, it adds the image description command of the acquired PS file 11 to the existing PS file.

At this time, the layout data generating unit 31a specifies the layout of the images to be generated by the image description command added to the existing PS file, and it adds the resulting layout data to the PS file 11. In other words, the layout data generating unit 31a sets the printing area for each printing resolution and lays out the images (specified by the image description command) in that part of the printing area (or margin) where the image has not yet been laid out. In this stage it only needs to know the size of the image but it does not need to parse the image description command entirely.

When generating the layout data, the layout data generating unit 31a sets a printing area and specifies the layout of images in the printing area. The printing area is set for each printing resolution and user's name, and it indicates the size of the area in which images can be printed. In this embodiment, the extent of traversal of the printing head is fixed and the extent of paper feed is variable according to the printing state. In other words, the size of the printing area is set up such that the extent of traversal of the printing head is fixed by the width of printing paper and the make of the printer but the extent of paper feed is so varied as to cover the lower end of the image depending on layout.

The extent of paper feed is fixed for sheet paper (with a predetermined length for one page) but is not limited for continuous paper. The data that specifies the printing area may be stored in the RAM during spooling or may be generated from the PS files 24a, 24b, etc. being spooled. In the latter case, the maximum printable area is calculated from the data that specifies the printing paper in the PS files 24a, 24b, etc.

The language interpreting unit 32 parses PostScript language as mentioned above, and it also retrieves the data 23 for printing start condition to see if the condition is met. If there exists a PS file of the user meeting the printing start condition, then it starts parsing the PostScript language. During parsing, a buffer area corresponding to the print page is allocated in the RAM and the input CMYK image data generated by parsing is placed in a position specified by the layout data.

The color engine 33 is a module that performs color conversion by referencing the profile. That is, it converts the CMYK value of the color of each pixel of the image into the Lab value by referencing the printing profile 21. It further converts the Lab value into the CMYK value (for use by the printer 15) by referencing the media profile 22. The half-tone processing unit 34 is a module which converts the CMYK value (after conversion mentioned above) into the dot data which causes ink to be ejected for each pixel by the printer 15. The print data generating unit 35 is a module to generate printing data for driving the ink ejection mechanism (not shown), or a printing head with ink nozzles, in the printer 15 according to the dot data. The resulting print data is transferred to the printer 15 through the printer I/F, and the printer 15 prints the images which have been properly laid out with a minimum of margin according to the print data.

(2) Printing Control Process:

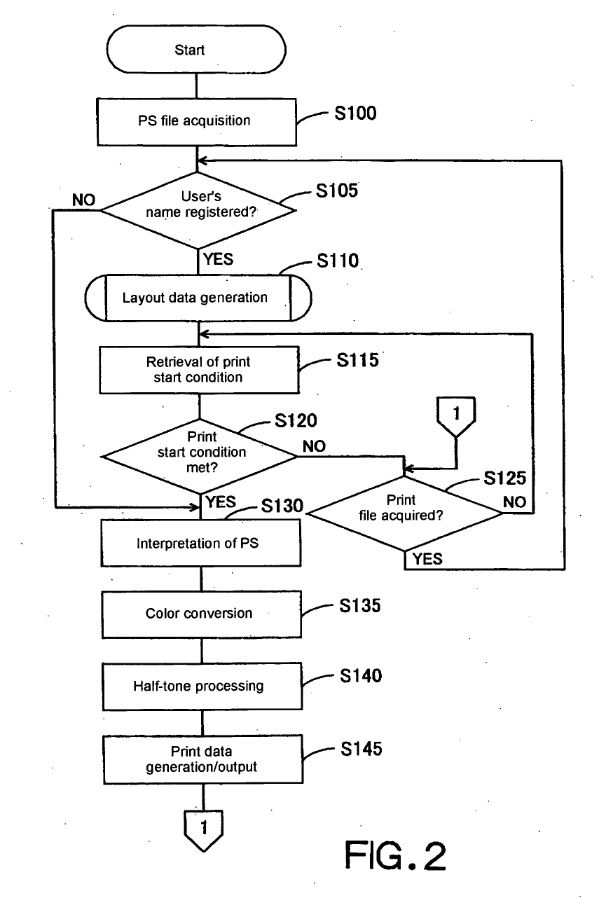

The printing control process in the above-mentioned configuration proceeds as explained below with reference to a flowchart. FIG. 2 is a flowchart to be followed by the printing control program 30. When a user creates the PS file 11 by using his PC and starts printing, the printing control program 30 receives the PS file 11 in Step S100 through a network (not shown). In Step S105, the language interpreting unit 32 acquires the user's name written in the PS file 11, and the spooling control unit 31 judges whether or not the thus acquired user's name has been registered with the data 23 for the printing start condition.

If it is judged in Step S105 that the user's name has already been registered, Step S110 is executed to create the layout data for printing in layout with a minimum of margin. In Step S115, the language interpreting unit 32 retrieves the printing start condition for all the users who have been registered with the data 23 for the printing start condition. In Step S120, it judges whether or not there exists any PS file which meets the printing start condition.

If it is judged in Step S120 that there exists no PS file which meets the printing start condition, then the print controlling program 30 judges in Step S125 whether or not any PS file relating to other print jobs has been received. If it is judged that no PS files relating to other print jobs have been received, the procedure that follows Step S115 is repeated. In other words, it waits until the printing start condition is met or a new PS file relating to other print jobs is received. If it is judged in Step S125 that any PS file relating to other print jobs has been received, then the procedure that follows Step S105 is repeated.

If it is judged in Step S120 that there exists a PS file that meets the printing start condition, then the language interpreting unit 32 acquires the PS file and parses the PostScript language in Step S130. As the result, the input CMYK image data is expanded in the RAM (not shown). At this time, each printing image is laid out in the position specified by the layout data, and the print profile and media profile to be used are specified.

In Step S1351, the color engine 33 references the specified print profile and media profile, thereby converting the input CMYK image data into the CMYK image data that describes colors in terms of the CMYK values used by the printer 15. In Step S140, the half-tone processing unit 34 converts the CMYK image data (which has been converted in the preceding step) into the dot data mentioned above. In Step S145, the print data generating unit 35 creates the print data (mentioned above) according to the dot data and sends it to the printer 15. As the result, the printer 15 prints the image according to the print data. This image is laid out in the printing area in which the printing resolution is common to all images. Thus the margin is minimized and the printing paper is saved.

On the other hand, if it is judged in Step S105 that the user name is not yet registered, the language interpreting unit 32 acquires the PS file 11 without performing the spooling process, and each module executes the processing that follows Step S130, thereby printing the images shown in the PS file.

(2-1) Layout Data Generation:

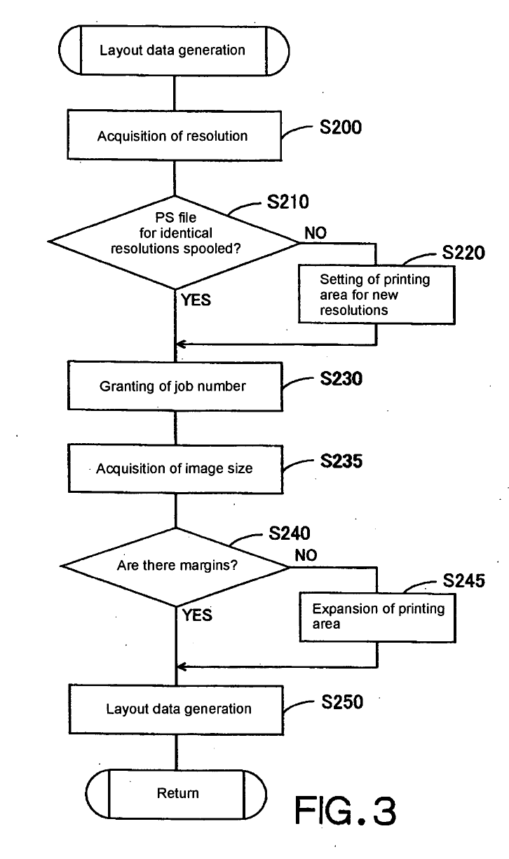

A detailed description is given below of the procedure for layout data generation in Step S110. FIG. 3 is a flow-chart of the procedure for layout data generation. In Step S200, the spooling control unit 31 acquires the resolution specified in the PS file 11 which is known to the language interpreting unit 32. In Step S210, it retrieves the PS file, and it judges whether or not the resolution is the same as that acquired previously and the PS file entered by the user has been spooled (it is supposed that the user has been registered in Step S105).

If it is judged in Step S210 that the PS file is not yet spooled, then, in Step S220, the layout data generating unit 31a sets up the printing area corresponding to the resolution acquired in Step S200. If it is judged in Step S210 that the PS file has already been spooled, the layout data generating unit 31a accomplishes the procedure for Step S220 and then grants the job number to the images of the PS file 11 in Step S230. This job number is a number which is sequentially granted to images in the order of spooling. The numbers are serial in a single PS file in the spool file 24.

Moreover, the job number is a number which associates a specific position specified by he layout data with an image in that position. Thus, the job number specifies the layout data which specifies the position of more than one image described in the common PS files 24a and 24b. (The PS files in FIG. 1 are granted the job numbers as the image description commands 1, 2, and 3.) In Step S235, the language interpreting unit 32 knows the image size from the image description command written in the PS file 11, and the layout data generating unit 31a acquires the image size. In Step S240, the language interpreting unit 32 judges whether or not there exists a margin in the printing area. If there exists the spool file 24 which specifies the same resolution as that to be spooled, then it appreciates the layout in the existing image printing area. If there exist no spool files 24 which specify the same resolution as that to be spooled (or if the procedure in Step S220 has been completed), then all of the printing areas are made blank.

Then, it judges whether or not there exists a margin for the laying out of images to be spooled. If it judges that there exists a margin, it creates the layout data in Step S250. If it is judged that there exists no margin, then, in Step S235, it expands the printing area in the longitudinal direction of printing paper until it becomes large enough for the laying out of images to be spooled, thereby securing a sufficient margin. In Step S250, it lays out the print image in the margin and generates the layout data. At this time, it associates the layout data with the job number granted in Step S230. If there exists the spool file which has specified the same resolution as that to be spooled, then it writes the layout data and the image description command in the spool file. If there exists no spool file which specifies the same resolution as that to be spooled, then it writes the layout data (generated as mentioned above) in the PS file 11 acquired in Step S100 and spools it in the HDD 12.

(3) Printing Control Action:

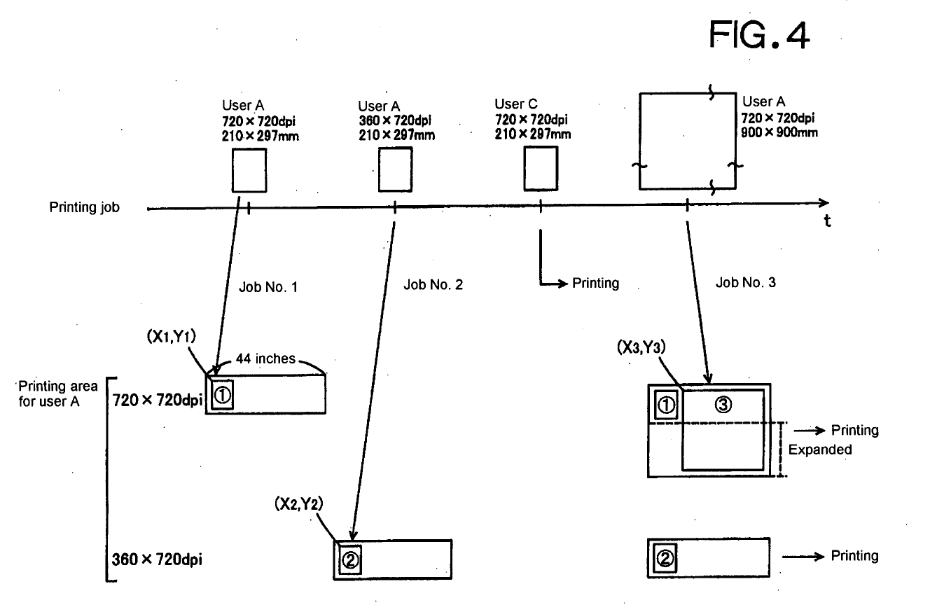

The printing control action that is achieved by the above-mentioned configuration and flow will be described below with reference to an actual example. FIG. 4 is a diagram showing the action that takes place when User A and User C enter the print job for the printing resolution and printing image size indicated in the upper part thereof. In FIG. 4, the arrow in the upper part thereof denotes the time axis; it shows that User A, User A, User C, and User A sequentially enter print jobs for images (720×720 dpi, 210×297 mm), (360×720 dpi, 210×297 mm), (720×720 dpi, 210×297 mm), and (720×720 dpi, 900×900 mm), respectively.

In FIG. 4, the printer 15 is a wideformat one with the printing head traversing rolled printing paper, 44 inches wide. As the data 23 for the printing start condition shows in FIG. 1, the printing start condition for User A is met when the number of jobs reaches 3. It is assumed that the printing start condition is not registered for User C. When User A initially enters an image (720×720 dpi, 210×297 mm), the printing control program 30 acquires the PS file 11 for the image. In Step S105, it judges that the printing start condition for User A has been registered as the data 23 for the printing start condition.

In Step S200, it acquires the printing resolution of 720×720 dpi. In Step S210, it judges that the PS file for this printing resolution is not spooled. Consequently, in Step S220, it secures a printing area for User A and the printing resolution of 720×720 dpi. The middle part of FIG. 4 shows the printing area for User A, which extends 44 inches in the lateral direction of printing paper. In this stage, the printing area (or the length in the lateral direction) should be 297 mm plus margin. If the printing area is smaller than this, it will be expanded later in Step S245.

In Step S230, it grants the job No. 1 to the print job. In Step S235, it acquires the printing image of a size measuring 210×297 mm. In Step S240, it confirms that there exists a margin, and in Step S250, it then lays out the printing image. In this example, no printing images are laid out yet in the printing area, and hence the printing image for the job No. 1 is laid out in the left-justified position. At this time, the layout data for the printing image is expressed in terms of coordinates, with the left upper end being X1 and Y1. It writes in the PS file these coordinates as the layout data for the job No. 1 and it assigns the image description command of this printing image to the image description command 1 (indicating the image of the job No. 1), which is spooled as the PS file 24a in the HDD 20.

In Steps S115 and S120 after spooling, it judges whether or not the printing start condition is met. Since only one job number has been granted and the printing start condition for User A is met when the number of jobs reaches 3, it waits entry of print jobs in the procedure after Step S125. Subsequently, User A enters the print job for the image (360×720 dpi, 210×297 mm), and then the printing control program 30 acquires the PS file 11. The printing start condition for User A is regarded as having been registered in Step S105.

In Step S200, it acquires the printing resolution of 360×720 dpi. This printing resolution is different from that of the PS file which has been spooled in Step S250. Therefore, the procedure for Step S220 is repeated, so that the printing area is secured for User A and the printing resolution of 360×72 dpi. In Step S230, this print job is given job No. 2, and in Step S250, the print image is laid out. In this instance, too, no printing images are laid out yet in the printing area, and hence the printing image for the job No. 2 is laid out in the left-justified position. The layout data for the printing image is expressed in terms of coordinates, with the left upper end being X2 and Y2. And, the PS file is spooled in the HDD 20.

Also, in Steps S115 and S120 after spooling, it waits entry of print jobs in the procedure after Step S125 because the job number does not yet reach 3. Then, User C enters the print job for an image of 720×720 dpi, 210×297 mm. Then, the printing control program 30 acquires the PS file 11. In Step S105, it is judged that the printing start condition for User C is not yet registered. Therefore, the procedure in Steps S105 to S125 is skipped and printing for the PS file 11 is executed by the procedure in Steps S130 to S145.

After printing has been performed for the print job entered by User C, the procedure after Step S125 waits again entry of the print job. Then, User A enters the print job for the image of 720×720 dpi, 900×900 mm. The printing control program 30 acquires the PS file 11. The printing start condition for User A is regarded as having been registered in Step S105.

In Step S200, it acquires the printing resolution of 720×720 dpi. The print job for this resolution has been spooled as the PS file 24a; therefore, in Step S230, it gives job No. 3 to this print job and performs the process for laying out. However, the printing area for 720×720 dpi shown in FIG. 4 does not have a sufficient margin in the longitudinal direction of printing paper. Therefore, after judgment in Step S240, it expands the printing area in the longitudinal direction of printing paper in Step S245. The expanded printing area is shown in the middle of FIG. 4. The broken line indicates the printing area before expansion.

After the printing area has been expanded, the print image of 900×900 mm can be laid next to the image of job No. 1 in the lateral direction of printing paper. It creates the layout data for the print image with coordinates (X3, Y3) denoting the upper left end. And, it spools the PS file in the HDD 20. After spooling, it retrieves the printing start condition in Steps S115 and S120, and it judges that the printing start condition is met because job No. 3 has been granted. In Steps S130 to S145, printing is carried out according to the PS file 24a and the PS file for the printing resolution 360×720 dpi.

(4) Additional Embodiments:

The above-mentioned embodiment is merely one example and it may be widely varied so long as it is capable of laying out printing images with identical resolutions in a printing area common to them, thereby reducing the margin. In the above-mentioned embodiment, more than one PC are connected to the printing control apparatus through a network and images are so laid out as to reduce margin when print jobs entered from each PC are executed. However, this configuration is not always essential.

A system may be configured such that, with the computer connected to the printer, the printing control program is executed in the computer in order to produce the layout that reduces margin. In other words, the printer driver, which is mounted on the computer, is provided with the spooling control unit as an additional function. It confirms the resolution each time the print job is entered and it performs spooling while laying out images in the common printing area if the resolutions are common to all the images. In this case, there is only one user and it is not necessary to associate the printing start condition with the user's name nor is it necessary to set up the printing areas for individual users.

Moreover, it is also possible to mount the printing control apparatus of the present invention on the printer. In this case, the printer is provided with memory (such as HDD and EPROM) for spooling and program executing device (such as CPU and RAM), so that the printing control program is executed within the printer. The printing control according to the present invention may be executed in the case of so-called direct printing, with an image device (such as digital camera) connected directly to the printer through USB cable, IEEE 1394 cable, or wireless network.

Also, in the above-mentioned embodiment, the print job data is a PS file; however, it may be written in any other page description language, and various file formats may be used, such as the one which consists of image data and additional data. Such file formats include “PRINT Image Matching” (registered trademark of Seiko Epson) and “EXIF 2.2” (registered trademark of Japan Electronics and Information Technology Association). In this case, necessary information such as resolution and image size are written in the file header.

What is claimed is:

1. A printing control apparatus which comprises a unit to acquire print job data for execution of print jobs, a unit to store in a prescribed recording medium the data for the printing start condition which indicates the condition under which execution of print jobs is started, a unit to spool the print job data while setting printing areas for each printing resolution, laying out printing images having the same printing resulting specified by the printing job data in the margin of the printing area for the same printing resolution, and generating layout data specifying the layout of images, and a unit to execute, according to the layout data, the printing of images specified by the print job data which has been spooled by the spooling unit.

2. The printing control apparatus as defined in claim 1, in which the spooling unit spools those in which printing resolutions specified by the print job data are identical as a single file which specifies the layout of printing images by the layout data.

3. The printing control apparatus as defined in claim 1, in which the spooling unit lays out images in the lateral direction of printing paper if the printing images in the print job data which has been entered later can be laid out in the lateral direction of printing paper in the margin of the printing area.

4. The printing control apparatus as defined in claim 1, in which the spooling unit expands the printing area in the longitudinal direction of printing paper if there exist no sufficient margins in the printing area which has been set up.

5. The printing control apparatus as defined in claim 1, in which the printing start condition is previously prescribed for each entity which enters the print job data.

6. The printing control apparatus as defined in claim 1, in which the printing start condition is prescribed by any of, or a combination of, the number of print jobs accumulated, the size of image to be printed according to the spooled print job, the time elapsed from the start of spooling, and the ratio of the prescribed printing area to the area occupied by the image.

7. A printing control method for executing printing by controlling the layout of images of the print jobs entered, said method comprising a step to acquire print job data for execution of print jobs, a step to spool the print job data while setting printing areas for each printing resolution, laying out printing images having the same printing resulting specified by the printing job data in the margin of the printing area for the same printing resolution, and generating layout data specifying the layout of images, and a step to execute, according to the layout data, the printing of images specified by the spooled print job data when the condition of start of the print job is met.

8. A printing control program for executing printing while controlling the layout of images of the print job which has been entered, which enables a computer to realize
a function to acquire print job data for execution of print jobs,
a function to store in a prescribed recording medium the data for the printing start condition which indicates the condition under which execution of print jobs is started,
a function to spool the print job data while setting printing areas for each printing resolution, laying out printing images having the same printing resulting specified by the printing job data in the margin of the printing area for the same printing resolution, and generating layout data specifying the layout of images, and
a function to execute, according to the layout data, the printing of images specified by the spooled print job data when the condition of start of the print job is met.

9. A printing control program product which generates printing data capable of controlling printing by a printer upon entry of a PostScript file describing the printing resolution, the user's name, and the image description command, said printing control program product comprising a spooling control unit, a language interpreting unit, a color engine, a half-tone processing unit, and a print data generating unit, and having previously registered therewith the printing start condition specifying the name of the user as the entity which enters the print job, wherein:
the language interpreting unit parses the PostScript language written in PostScript style and retrieves the data for the printing start condition to judge whether or not the printing start condition is met, and, if there exists a PostScript file of the user for whom the printing start condition is met, acquires the PostScript file to execute the parsing of the language, and buffers the input CMYK image data generated by the language parsing in a position specified by prescribed layout data,
the spooling control unit, when the printing control apparatus acquires the PostScript file, acquires the printing resolution and user's name parsed by the language interpreting unit, if the data of the printing start condition has been registered for the acquired user's name, spools the acquired PostScript file, judges whether or not the other PostScript film common based on the acquired user's name and the printing resolution, if it has been spooled, adds the image description command of the acquired PostScript file to the existing PostScript file,
at this time, the layout data generating unit sets the printing area for each printing resolution, generates the layout data so that the images described in the image description command are laid out in the position of the printing area where the images is not laid out, adding the layout data to the PostScript file,
the color engine converts the CMYK value in the input CMYK image data showing the color of each pixel of the image into the Lab value by referencing the printing profile and converts the Lab value into the CMYK value for use by the printer by referencing the media profile,
the half-tone processing unit converts the converted CMYK value into the dot data which shows the presence or absence of ink ejection for each pixel in the printer, and
the printing data generating unit creates the printing data to drive the printer based on the dot data.
